(19) United States
(12) Patent Application Publication
(10) Pub. No.: US 2024/0236011 A1
(43) Pub. Date: Jul. 11, 2024

(54) TUNNEL AGGREGATION BASED OPTIMIZATION IN A MULTI-CLOUD ARCHITECTURE

(71) Applicant: International Business Machines Corporation, Armonk, NY (US)

(72) Inventors: Pravein Govindan Kannan, Bangalore (IN); Palanivel Andiappan Kodeswaran, Bangalore (IN); SAYANDEEP SEN, Bangalore (IN)

(21) Appl. No.: 18/150,253

(22) Filed: Jan. 5, 2023

(51) Int. Cl. H04L 47/43

(52) U.S. Cl. CPC H04L 47/43

(57) ABSTRACT

Embodiments are related to providing tunnel aggregation based optimization in a multi-cloud architecture. The optimization includes receiving packets to be sent over a communication network and determining the packets that have a predefined traffic class. The optimization includes combining the packets having the predefined traffic class into an aggregated packet, the aggregated packet including an aggregated packet header. The optimization includes transmitting the aggregated packet over the communication network.

### BACKGROUND

The present invention generally relates to computer systems, and more specifically, to computer-implemented methods, computer systems, and computer program products configured and arranged for providing tunnel aggregation based optimization in a multi-cloud architecture. Embodiments relate to optimizing network performance in multi-cluster and/or multi-cloud environments.

In telecommunications and computer networking, a network packet is a formatted unit of data carried by a packet-switched network. A packet consists of control information and user data. User data is also known as the payload. Control information provides data for delivering the payload (e.g., source and destination network addresses, error detection codes, or sequencing information). Typically, control information is found in packet headers and trailers.

A packet is also called a datagram, a segment, a block, a cell or a frame, depending on the protocol used for the transmission of data. When data has to be transmitted, it is broken down into similar structures of data before transmission, called packets, which are reassembled to the original data chunk once they reach their destination. The structure of a packet depends on the type of packet it is and on the protocol. Normally, a packet has a header and a payload. The header keeps overhead information about the packet, the service, and other transmission-related data. For example, data transfer over the Internet requires breaking down the data into Internet Protocol (IP) packets, and an IP packet generally includes the following. The source IP address, which is the IP address of the machine sending the data. The destination IP address, which is the machine or device to which the data is sent. The sequence number of the packets, a number that puts the packets in order such that they are reassembled in a way to get the original data back exactly as it was prior to transmission.

### SUMMARY

Embodiments of the present invention are directed to computer-implemented methods for providing tunnel aggregation based optimization in a multi-cloud architecture. A non-limiting computer-implemented method includes receiving packets to be sent over a communication network, determining the packets that have a predefined traffic class, and combining the packets having the predefined traffic class into an aggregated packet, the aggregated packet including an aggregated packet header. The computer-implemented method includes transmitting the aggregated packet over the communication network.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of the example computing environment configured with further details for providing tunnel aggregation based optimization in a multi-cloud architecture according to one or more embodiments of the present invention;

FIG. 3A is a flowchart of a computer-implemented method for packet aggregation according to one or more embodiments of the present invention;

FIG. 3B is a flowchart of a computer-implemented method further detailing the aggregation of packets in an example aggregated packet with conditions for when to send the aggregated packet according to one or more embodiments of the present invention;

FIG. 3C is a flowchart of a computer-implemented method for packet de-aggregation according to one or more embodiments of the present invention;

FIG. 4A depicts a block diagram of an example of packet aggregation according to one or more embodiments of the present invention;

FIG. 4B depicts a block diagram of an example of packet de-aggregation according to one or more embodiments of the present invention;

FIG. 5 depicts a block diagram of an example of the placement of aggregation services according to one or more embodiments of the present invention;

FIG. 6 depicts Table 1 according to one or more embodiments of the present invention;

FIG. 7 depicts a block diagram of an example of aggregation aware cluster selection according to one or more embodiments of the present invention;

FIG. 8 depicts Table 2 according to one or more embodiments of the present invention; and

FIG. 9 is a flowchart of a computer-implemented method for tunnel aggregation based optimization in a multi-cloud architecture according to one or more embodiments of the present invention.

### DETAILED DESCRIPTION

One or more embodiments of the invention describe computer-implemented methods, computer systems, and computer program products configured and arranged to provide tunnel aggregation based optimization in a multi-cloud architecture, which optimizes network performance in multi-cluster and/or multi-cloud environments. The system and method optimize cross cluster network traffic by aggregating packets having the same source or destination cluster within a bounded delay and/or by scheduling the aggregation of packets opportunistically at different points in the topology based on their traffic class. The aggregation of packets into a large, aggregated packet is performed with traffic-class awareness.

In the state-of-the-art, multi-cluster communication is established through cluster-level gateways that implement a tunnelling protocol such as Generic Network Virtualization Encapsulation (GENEVE), Virtual extensible Local Area Network (VXLAN), etc. Each multi-cluster packet destined from a given source (src) cluster to a destination cluster incurs tunnel header encapsulation and decapsulation overhead and is not optimized for end-application performance. Micro-services typically have small payloads of less than 200 bytes, while headers such as GENEVE could add overhead of approximately (˜) 25% of the payload, which is approximately an additional 50 bytes added to the payload. Adding a tunnel overhead for each packet that is destined to the same destination cluster results in a waste of expensive wide area network (WAN) bandwidth.

Accordingly, one or more embodiments provide techniques for aggregating smaller packets across clusters into an aggregated packet and adding a single tunnel header to the large, aggregated packet. One or more embodiments can provide packet aggregation across clusters to improve WAN utilization. Traffic-class awareness is utilized during cross-cluster scheduling of requests, and aggregation can be performed on a single (switch) component and/or more than one component. There are various technical solutions and benefits to optimizing the WAN link utilization for microservice based traffic that is deployed on multiple clusters across the WAN. For example, the optimization increases throughput on WAN links between clusters, provides a bounded delay, is operable to be deployed across the topology (e.g., at edge computers, gateways, transit gateways, service nodes, etc.), and is traffic-class aware.

The network traffic of a network may contain hundreds, thousands, and/or millions of network packets, all of which is referred to as “big data”. In accordance with one or more embodiments, the enormous size and speed of network packet traffic requires management, processing, and search by a machine (such as computer 101), for example, using computer-executable instructions; network packets across the network could not be practically managed, stored, analyzed, and/or processed as discussed herein within the human mind. Embodiments optimize network flow between computers, and accordingly, improve the operations of computers and networks that connect computers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as packet optimization code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

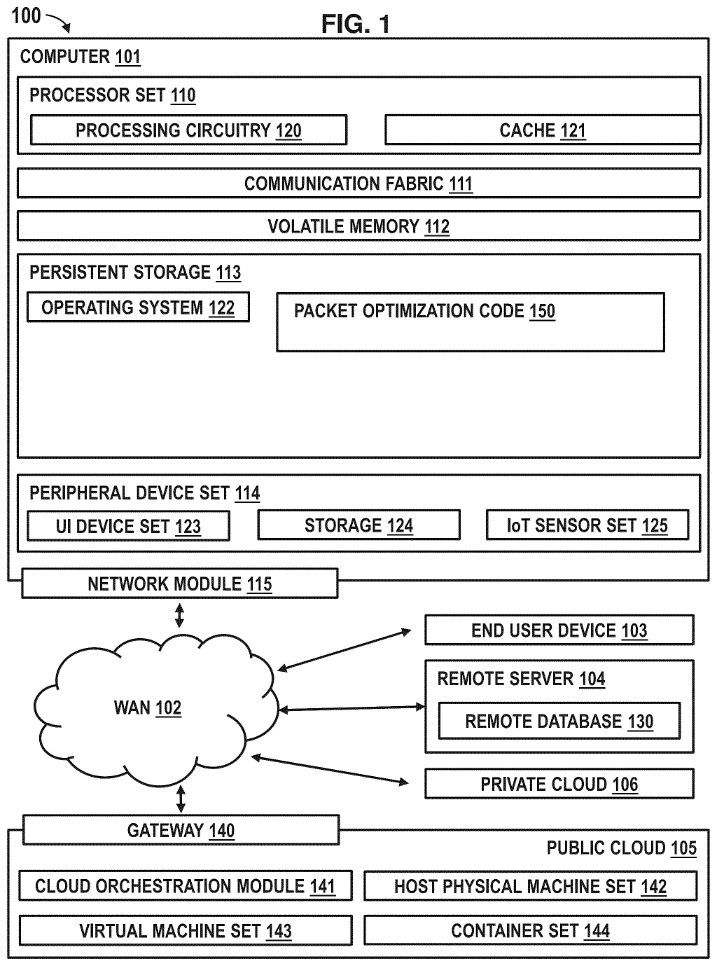

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

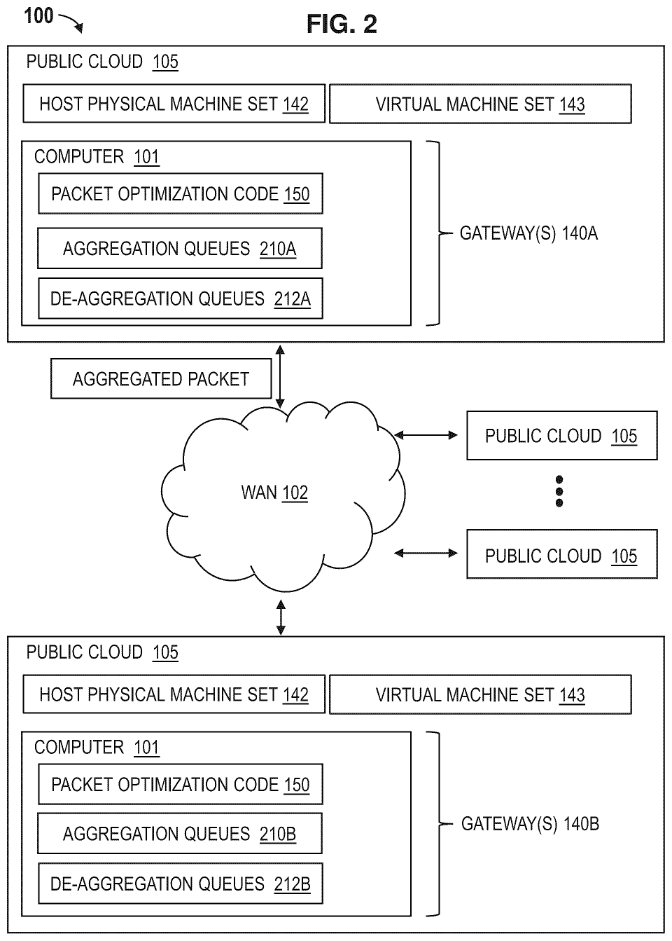

FIG. 2 depicts the computing environment 100 with further details for providing tunnel aggregation based optimization in a multi-cloud architecture according to one or more embodiments. In FIG. 2 and other figures herein, some details of the computing environment 100 may be omitted so as not to obscure the figure while new details are presented. FIG. 2 represents numerous public clouds 105, which can communicate with each other over the WAN 102. Each of the public clouds 105 includes one or more of its own computer 101 which can be one of the host physical machines in the host physical, part of a switch, a gateway 140, and/or implemented in any other node within the public cloud 105. The computer 101 includes the packet optimization code 150 configured to aggregate smaller packets into a single aggregated packet of maximum transmission unit (MTU) size and add a single tunnel header within an operator-tuned delay bound. The packet optimization code 150 may include the functionality of, be coupled to, and/or call various algorithms, application programming interfaces (APIs), and/or other pieces of known software to operate as discussed herein.

For explanation purposes, one public cloud 105 is illustrated as having a gateway 140A and another public cloud 105 is illustrated as having a gateway 140B in FIG. 2. Both of the gateways 140A, 140B can generally be referred to as gateways 140. Any discussion for the gateway 140A applies by analogy to the gateway 140B, and vice versa. Although examples may discuss the optimization of communications between public clouds, embodiments are not meant to be limited to public clouds. Communications can be between clouds of any type.

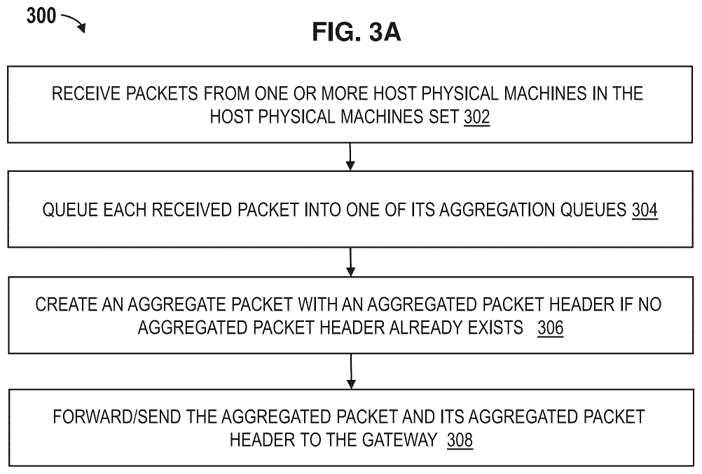

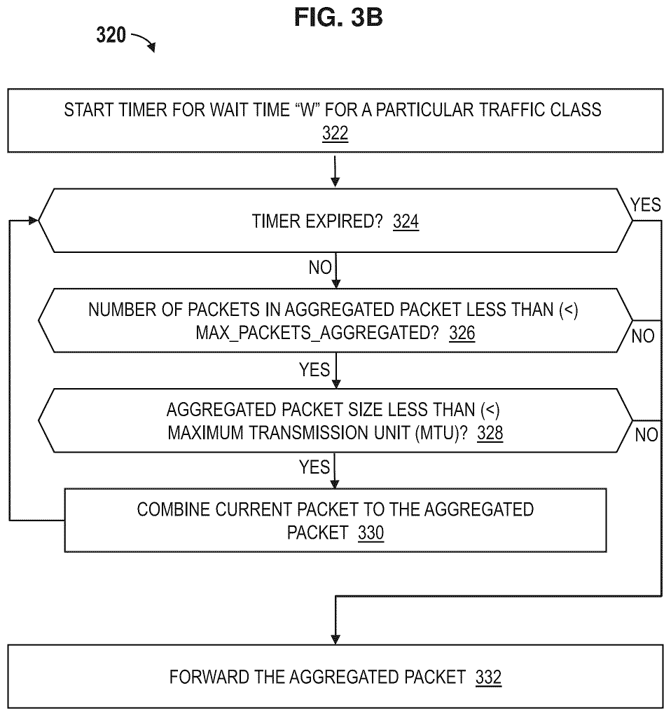

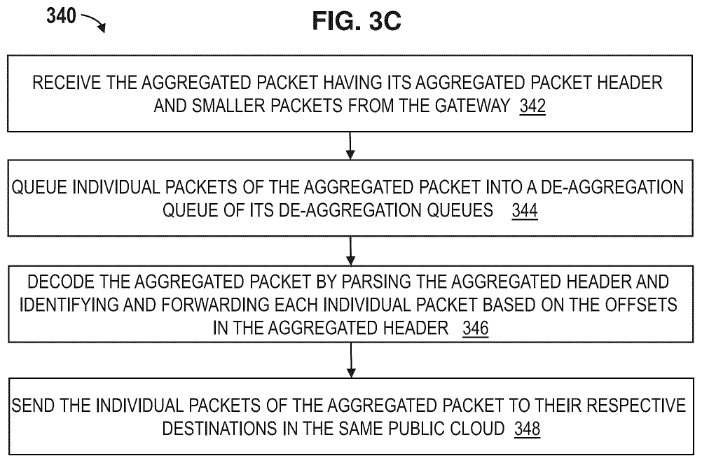

FIG. 3A is a flowchart of a computer-implemented method 300 for packet aggregation according to one or more embodiments. FIG. 3A illustrates an example scenario of the gateway 140A preparing and sending an aggregated packet to the gateway 140B.

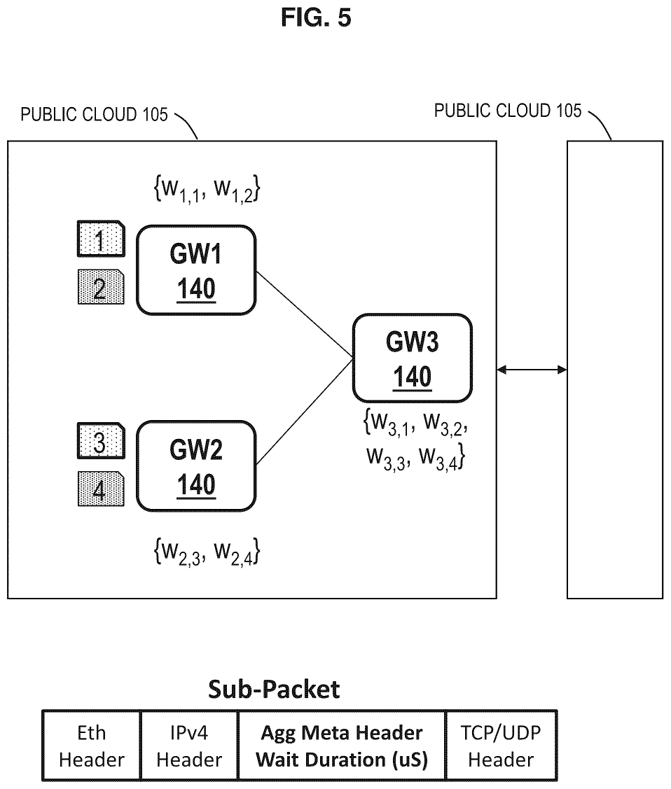

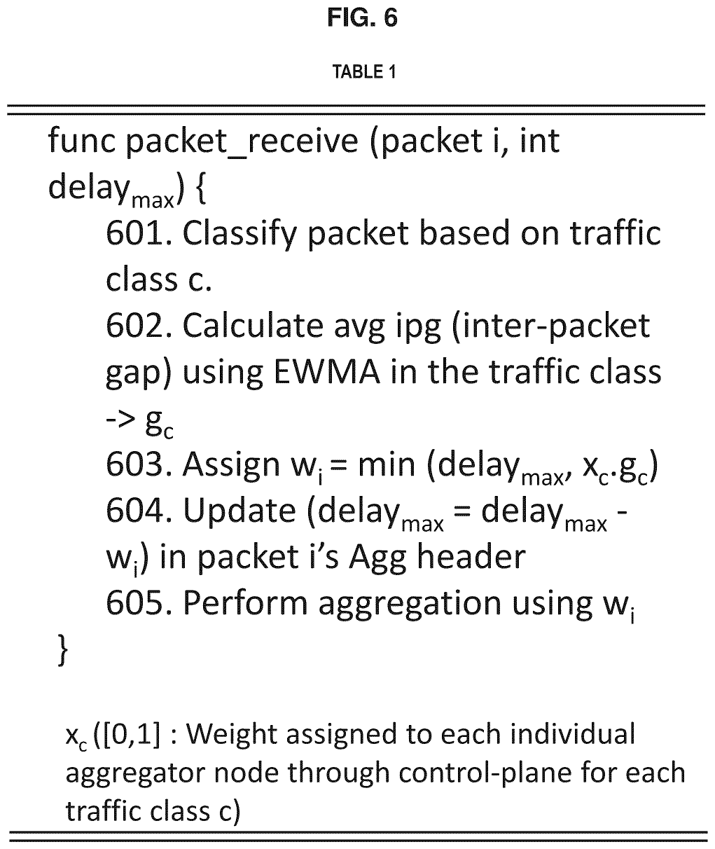

At block 302 of the computer-implemented method 300, the packet optimization code 150 of the gateway 140A is configured to receive packets from one or more host physical machines in the host physical machines set 142. In some cases, the host physical machines may be running virtual machines in the virtual machine set 143 that have sent one or more of the packets. In some cases, the gateway 140A may receive the packets from other gateways 140 in the same public cloud 105 as the gateway 140A, as discussed further in FIGS. 5 and 6.

At block 304, the packet optimization code 150 of the gateway 140A is configured to queue each received packet into one of its aggregation queues 210A. Similarly, the gateway 140B has its own aggregation queues 210B. The aggregation queues 210A, 210B may generally be referred to as aggregation queues 210. The packet optimization code 150 can inspect each incoming packet for its traffic class and/or employ another software application to perform the inspection. The packet optimization code 150 utilize functionality of the Extended Berkeley Packet Filter (eBPF), Programming Protocol-independent Packet Processors (P4), and/or other known software for processing packets. The packet optimization code 150 may parse each packet for its destination and add each packet to the particular one of the aggregation queues 210 corresponding to its traffic class.

In some embodiments, the aggregation queues 210A, 210B include per destination queues. There can be numerous aggregation destination queues, at least one for each different destination. An example destination is an IP address, a cluster, etc., to another public cloud. A cluster can be a group of computers in a public cloud 105. For example, a computer cluster is a group of servers (or nodes) that act like one system in the public cloud. Also, a cluster can be a group of nodes hosted on virtual machines and connected within a virtual private cloud.

At block 306, the packet optimization code 150 of the gateway 140A is configured to create an aggregated packet with an aggregated packet header if no aggregated packet header already exists. The aggregated packet is a single large packet that holds multiple small packets according to their traffic class to be sent to the destination, such as another public cloud, where the aggregated packet has a single aggregated packet header for all of its packets. As one example, a traffic class can be based on the destination of the packet. Another traffic class can be based on the source of the packet. Other traffic classes for packets can be based on port numbers, batch processing, latency sensitive (e.g., sensitive traffic, best-effort traffic, undesired traffic), etc. The aggregated packet houses the group of packets as a single unit and is sent across the network.

At block 308, the packet optimization code 150 of the gateway 140A in one public cloud 105 is configured to forward/send the aggregated packet along with its single aggregated packet header to the gateway 140B in another public cloud 105. The multiple individual packets are sent together in the large, aggregated packet under the same aggregated packet header, thus reducing the bandwidth of each smaller packets having its own header.

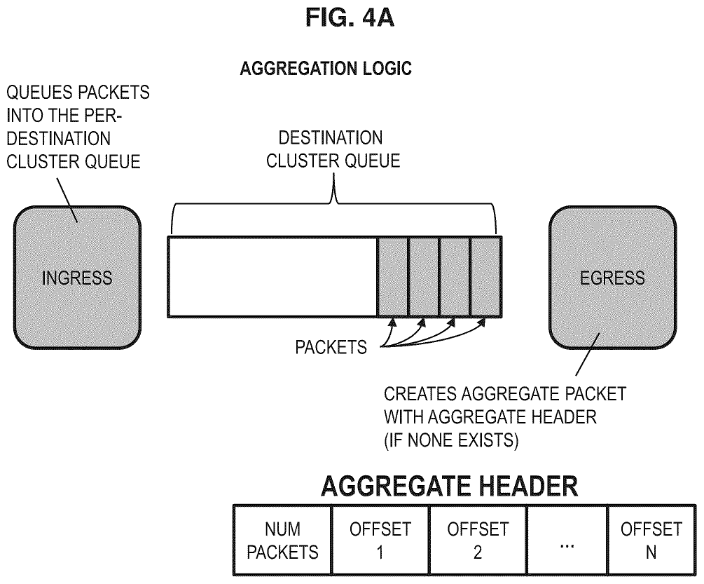

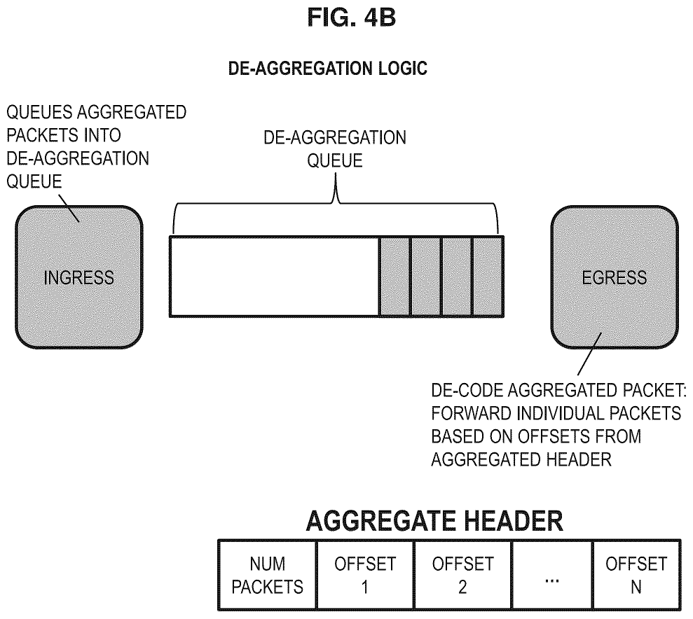

FIG. 3B is a flowchart of a computer-implemented method 320 further detailing the aggregation of packets in an example aggregated packet with conditions for when to send the aggregated packet according to one or more embodiments. FIG. 3B illustrates an algorithm of the packet optimization code 150 executed during the processing in FIG. 3A. In FIG. 3B, the example scenario is discussed for a particular aggregated packet using one aggregation queue but applies by analogy to multiple aggregated packets being simultaneously created. FIG. 4A depicts a block diagram of an example of packet aggregation according to one or more embodiments. In FIG. 4A, an example destination cluster queue is illustrated as the aggregation queue 210. FIG. 4A shows that the destination queue is being filled with packets that are in the same traffic class, which is the same destination cluster in this example. Other aggregation queues 210 may have different traffic classes. The packet optimization code 150 has created the aggregated packet header that includes the total number of packets and the offsets from one packet to the next packet in the aggregated packet. The aggregated packet header is combined with smaller packets to form the aggregated packet.

Referring to FIG. 3B, at block 322, the packet optimization code 150 of the gateway 140A is configured to start a timer w for the life of the aggregated packet before it is sent. The timer w can be for a predetermined time set by an operator, such as a few microseconds (us). At block 324, the packet optimization code 150 of the gateway 140A is configured to check if the timer is expired. If (No) the timer is not expired, the packet optimization code 150 of the gateway 140A checks if the number of packets in the aggregated packet (thus far) is less than a maximum number of packets aggregated (e.g., Pckts<Max_Packets_Aggregated), at block 326. The maximum number of packets is a predefined value. If (Yes) the number of packets is less than the maximum number of packets aggregated, the packet optimization code 150 of the gateway 140A checks if the aggregated packet size is less than the maximum transmission unit (MTU) size, at block 328. If (Yes) the aggregated packet size of the aggregated packet is less than the MTU, the packet optimization code 150 of the gateway 140A is configured to combine the current packet into the aggregated packet, at block 330; the flow returns to block 324. At block 332, if the timer is expired at block 324, if the maximum number of packets aggregated in the aggregated packet is reached at block 326, or if the MTU is reached at block 328, the packet optimization code 150 of the gateway 140A is configured to forward the aggregated packet along with the aggregated packet header to the destination, such as to the gateway 140B in another public cloud 105.

FIG. 3C is a flowchart of a computer-implemented method 340 for packet de-aggregation according to one or more embodiments. FIG. 3C illustrates an example scenario of the gateway 140B receiving the aggregated packet from the gateway 140A.

At block 342, the packet optimization code 150 of the gateway 140B is configured to receive the aggregated packet having its aggregated packet header and smaller packets from the gateway 140A. As seen in FIG. 2, the gateways 140A, 140B are in different public clouds 105.

At block 344, the packet optimization code 150 of the gateway 140B is configured to queue individual packets of the aggregated packet into a de-aggregation queue of its de-aggregation queues 212A. The de-aggregation queues 212A, 212B may generally be referred to as de-aggregation queues 212. The packet optimization code 150 can inspect each incoming aggregated packet and place its packets in the de-aggregation queue 212. FIG. 4B depicts a block diagram of an example of packet de-aggregation according to one or more embodiments. In FIG. 4B, an example de-aggregation queue is shown as one of the de-aggregation queues 212. FIG. 4B illustrates that the de-aggregation queue 212 is being filled with packets from the incoming aggregated packet to be distributed.

Referring to FIG. 3C, at block 346, the packet optimization code 150 of the gateway 140B is configured to decode the aggregated packet by parsing the aggregated header and identifying each individual packet based on the offsets, in preparation to forward each individual packet based on the offsets in the aggregated header. The offsets in the aggregated packet header delineate the locations of each individual packet in the aggregated packet, although the individual packets may appear as a single, large payload.

At block 348, the packet optimization code 150 of the gateway 140B in public cloud 105 is configured to send the individual packets of the aggregated packet to their respective destinations in the same public cloud 105. For example, individual packets may be sent to switches, virtual machines on host physical machines, clusters, etc., all of which is within the same public cloud 105 as the gateway 140B. In some cases, the individual packets may be sent to other gateways 140 within the same public cloud 105 as the gateway 140B.

FIG. 5 depicts a block diagram of an example of the placement of aggregation services according to one or more embodiments. Aggregation can be performed in the public cloud 105 hierarchically, for example, at switches, gateways, etc. This reduces the overall load at the final gateway by distributing packet aggregation onto computers 101 across, for example, multiple gateways 140 in the same public cloud 105. In FIG. 5, the gateways 140 in the same public cloud 105 are illustrated as GW1, GW2, and GW3. The packet optimization code 150 of the gateways 140 (e.g., GW1, GW2, GW3) is configured to execute the algorithm in Table 1 in FIG. 6. The algorithm in Table 1 illustrates how to distribute aggregation services between aggregator gateways such that traffic classification is not lost and that the final gateway does not bear the entire load of packet aggregation. In other words, some packets are aggregated by one or more gateways prior to reaching the final gateway.

In this example scenario, the individual gateways 140 (e.g., GW1 and GW2) act as individual aggregator nodes internal to the public cloud 105 and send their output of sub-aggregated packets to a final gateway 140 (GW3) to create various aggregated packets based on traffic classes. Each gateway 140 (GW1 and GW2) is assigned a weight x_{c}, where xₑ is a value [0,1] for a weight assigned to each individual aggregator node (GW1 and GW2) by a control plane for each traffic class c. Although discussion is for the gateway GW1, the operations below are performed separately by the packet optimization code 150 in each individual gateway 140 (GW1 and GW2) prior to reaching the final gateway 140 (GW3). The assumption is that the gateway 140 (GW1) receives a (sub-aggregated) packet i with an initial maximum delay, int delayₘₐₓ. GW1 can assign the int delayₘₐₓ, or it may be a predefined value.

Referring to FIG. 6, at operation 601, GW1 classifies the received packet into a traffic class c. For example, traffic class c could be class 1 for batch processing or class 2 for latency sensitive, depicted in FIG. 5. At operation 602, GW1 calculates an average inter-packet gap g_{c} in the traffic class c. The inter-packet gap g_{c} can be predefined in advance, or determined based on historical data for the traffic class c. The inter-packet gap g_{c} can be determined using the exponential weighted moving average (EWMA). The inter-packet gap g_{c} is how long to wait to receive the next packet in the same traffic class c before GW1 forwards the sub-aggregated packet to the final gateway GW3.

At operation 603, GW1 assigns a wait time wᵢ for the particular traffic class c that is being queued in the aggregation queue 210, where the wait time wᵢ is the minimum of the delayₘₐₓ or x_{c}·g_{c} (e.g., assign wᵢ=min (delayₘₐₓ, x_{c}·g_{c})). The GW1 can have multiple aggregation queues 210, one for each type of traffic class c. The same type of traffic class c is added to a particular aggregation queue 210.

At operation 604, GW1 updates the maximum delay (e.g., delayₘₐₓ =delayₘₐₓ-wᵢ) in the aggregator metadata header for the individual sub-aggregated packet i. FIG. 5 illustrates the aggregator metadata header for packets being queued in the sub-aggregated packet. The aggregator metadata header is temporarily used for the sub-aggregated packet to hold the maximum delay (delay) for the sub-aggregated packet i, before the sub-aggregated packet i is sent to the final gateway GW3.

At operation 605, GW1 performs aggregation as discussed but for the sub-aggregated packet that has its own aggregator metadata header, where the sub-aggregated packet i contains smaller packets. GW1 sends the sub-aggregated packet i and its aggregator metadata header to the final GW3. GW3 adds the new sub-aggregated packet i to the aggregated packet (along with old packets) for the same traffic class c as sub-aggregated packet i, according to the aggregator metadata header. The final gateway GW3 removes the aggregator metadata header for the sub-aggregated packet i, which has now been combined into the aggregated packet having its own aggregated header as illustrated in FIG. 4A.

In FIG. 6, in advance, the operator can set weights x_{c} for each traffic class c, and set delayₘₐₓ for each traffic class c. It should be appreciated that each aggregator gateway/node (e.g., GW1 and GW2) has a wait duration taken locally based on average inter packet gaps, and this decision is passed downstream until reaching the final gateway (GW3). The final gateway (GW3) combines all the sub-aggregated packets into an aggregated packet according to traffic class.

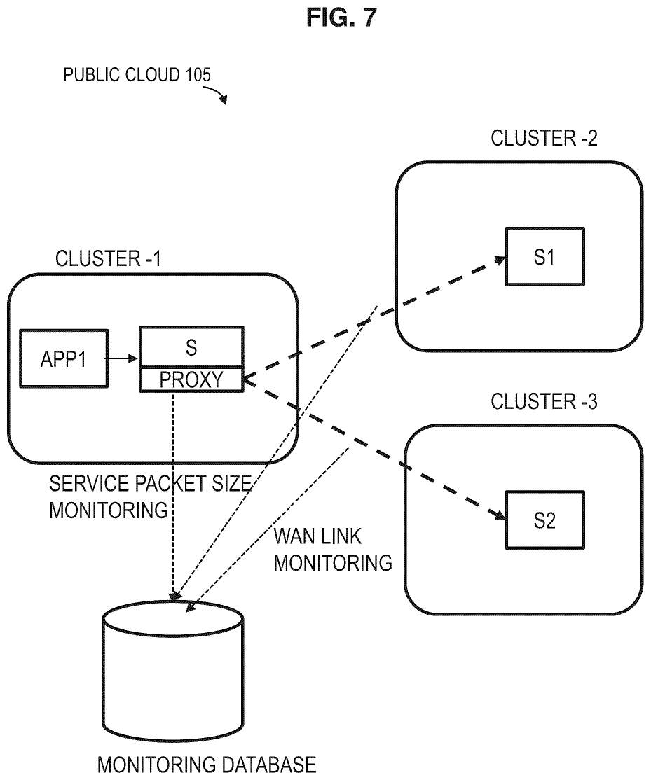

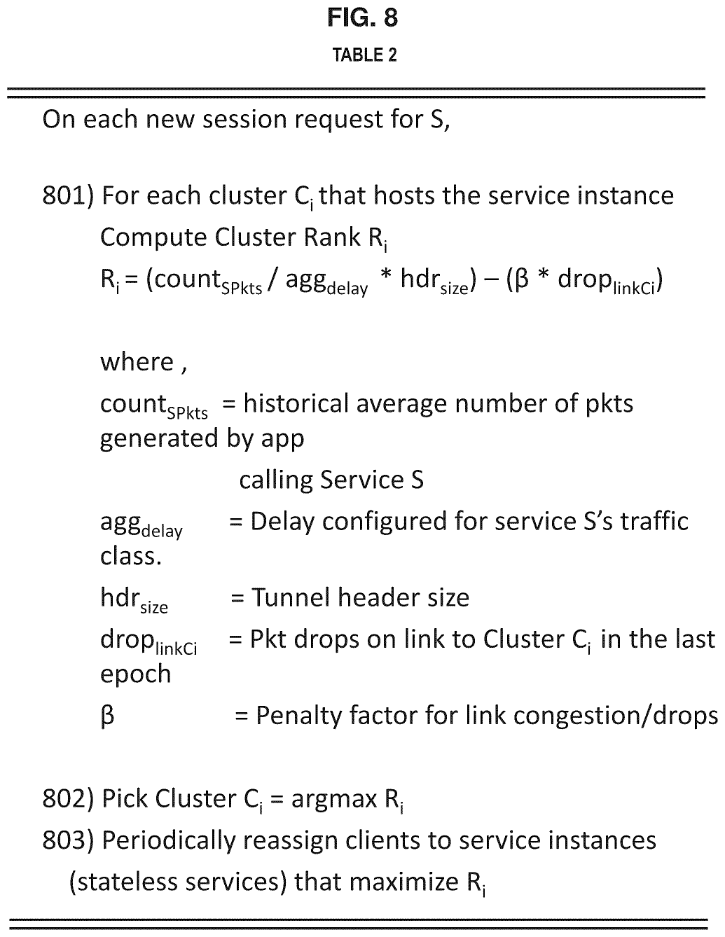

FIG. 7 depicts a block diagram of an example of aggregation aware cluster selection according to one or more embodiments. Aggregation can be performed in the public cloud 105 hierarchically to maximize aggregation benefits while minimizing WAN link congestion/latency. In FIG. 7, there are three clusters, which are clusters 1, 2, and 3, illustrated in the same public cloud 105. Each cluster has its own packet optimization code 150 in a gateway 140 to perform the algorithm shown in Table 2 of FIG. 8. At operation 801, upon request for a service instance among clusters (e.g., cluster 1, 2, 3) provided by packet optimization code 150, a computation of the cluster rank is performed. At operation 802, when a decision on choosing a service from the clusters needs to be taken, a cluster is selected that has the highest rankRᵢ. At operation 803, clients are periodically reassigned to services at the cluster that maximizeR_{i.}

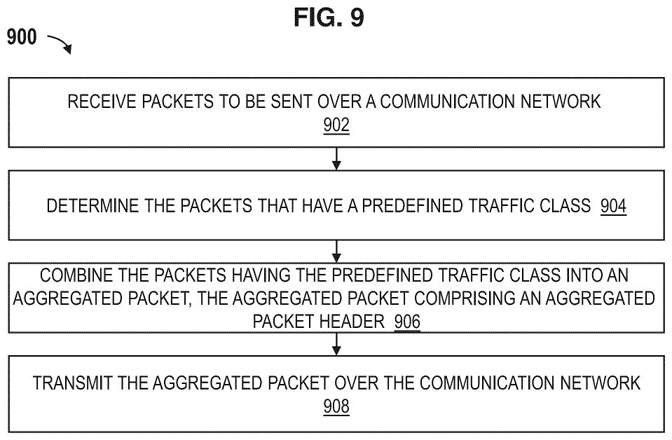

FIG. 9 is a flowchart of a computer-implemented method 900 for tunnel aggregation based optimization in a multi-cloud architecture according to one or more embodiments. Reference can be made to any of the figures discussed herein. At block 902 of the computer-implemented method 900, the patent optimization code 150 (of, e.g., gateway 140A) is configured to receive packets to be sent over a communication network. At block 904, the patent optimization code 150 is configured to determine the packets that have or meet a predefined traffic class. At block 906, the patent optimization code 150 is configured to combine the (smaller) packets having the predefined traffic class into an aggregated packet, the (large) aggregated packet including an aggregated packet header. The smaller packets correspond to a microservice, and the smaller packets typically have a payload of less than 200 bytes. The aggregated packet is formed to combine the smaller packets thereby including the payload of each of the smaller packets. At block 908, the patent optimization code 150 is configured to transmit the aggregated packet over the communication network (e.g., WAN 102). For example, the gateway 140A in public cloud 105 can send the large, aggregated packet over the WAN 102 to the gateway 140B in different public cloud 105. The large, aggregated packet includes the payloads of all the smaller packets under the single aggregated packet header.

In one or more embodiments, the predefined traffic class is a destination. The packets having the predefined traffic class are combined into the aggregated packet until a timer (w) expires, the aggregated packet being transmitted over the communication network in response to the timer expiring. The packets having the predefined traffic class are combined into the aggregated packet until a maximum transmission unit (MTU) limit is reached for the aggregated packet, the aggregated packet being transmitted over the communication network in response to the MTU limit being reached.

The aggregated packet header includes offsets that delineate a location for each of the packets combined in the aggregated packet. The aggregated packet header is configured to be utilized to individually delineate and distribute the packets combined in the aggregated packet in accordance with offsets. Prior to receiving the packets to be sent over the communication network, two or more of the packets have been previously aggregated by a gateway (e.g., gateways GW1 and/or GW2) based on the predefined traffic class; combining the packets having the predefined traffic class into the aggregated packet includes automatically adding (e.g., by gateway GW3) the two or more of the packets in the aggregated packet based on the two or more of the packets having been previously aggregated by the gateway.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving packets to be sent over a communication network;
determining the packets that have a predefined traffic class;
combining the packets having the predefined traffic class into an aggregated packet, the aggregated packet comprising an aggregated packet header; and
transmitting the aggregated packet over the communication network.

2. The computer-implemented method of claim 1, wherein the predefined traffic class is a destination.

3. The computer-implemented method of claim 1, wherein the packets having the predefined traffic class are combined into the aggregated packet until a timer expires, the aggregated packet being transmitted over the communication network in response to the timer expiring.

4. The computer-implemented method of claim 1, wherein the packets having the predefined traffic class are combined into the aggregated packet until a maximum transmission unit (MTU) limit is reached for the aggregated packet, the aggregated packet being transmitted over the communication network in response to the MTU limit being reached.

5. The computer-implemented method of claim 1, wherein the aggregated packet header comprises offsets that delineate a location for each of the packets combined in the aggregated packet.

6. The computer-implemented method of claim 1, wherein the aggregated packet header is configured to be utilized to individually delineate and distribute the packets combined in the aggregated packet in accordance with offsets.

7. The computer-implemented method of claim 1, wherein:
prior to receiving the packets to be sent over the communication network, two or more of the packets have been previously aggregated by a gateway based on the predefined traffic class; and
combining the packets having the predefined traffic class into the aggregated packet comprises automatically adding the two or more of the packets in the aggregated packet based on the two or more of the packets having been previously aggregated by the gateway.

8. A system comprising:
a memory having computer readable instructions; and
a computer for executing the computer readable instructions, the computer readable instructions controlling the computer to perform operations comprising:
receiving packets to be sent over a communication network;
determining the packets that have a predefined traffic class;
combining the packets having the predefined traffic class into an aggregated packet, the aggregated packet comprising an aggregated packet header; and
transmitting the aggregated packet over the communication network.

9. The system of claim 8, wherein the predefined traffic class is a destination.

10. The system of claim 8, wherein the packets having the predefined traffic class are combined into the aggregated packet until a timer expires, the aggregated packet being transmitted over the communication network in response to the timer expiring.

11. The system of claim 8, wherein the packets having the predefined traffic class are combined into the aggregated packet until a maximum transmission unit (MTU) limit is reached for the aggregated packet, the aggregated packet being transmitted over the communication network in response to the MTU limit being reached.

12. The system of claim 8, wherein the aggregated packet header comprises offsets that delineate a location for each of the packets combined in the aggregated packet.

13. The system of claim 8, wherein the aggregated packet header is configured to be utilized to individually delineate and distribute the packets combined in the aggregated packet in accordance with offsets.

14. The system of claim 8, wherein:
prior to receiving the packets to be sent over the communication network, two or more of the packets have been previously aggregated by a gateway based on the predefined traffic class; and
combining the packets having the predefined traffic class into the aggregated packet comprises automatically adding the two or more of the packets in the aggregated packet based on the two or more of the packets having been previously aggregated by the gateway.

15. A computer program product comprising a computer readable storage medium having program instructions embodied therewith, the program instructions executable by a computer to cause the computer to perform operations comprising:
receiving packets to be sent over a communication network;
determining the packets that have a predefined traffic class;
combining the packets having the predefined traffic class into an aggregated packet, the aggregated packet comprising an aggregated packet header; and
transmitting the aggregated packet over the communication network.

16. The computer program product of claim 15, wherein the predefined traffic class is a destination.

17. The computer program product of claim 15, wherein the packets having the predefined traffic class are combined into the aggregated packet until a timer expires, the aggregated packet being transmitted over the communication network in response to the timer expiring.

18. The computer program product of claim 15, wherein the packets having the predefined traffic class are combined into the aggregated packet until a maximum transmission unit (MTU) limit is reached for the aggregated packet, the aggregated packet being transmitted over the communication network in response to the MTU limit being reached.

19. The computer program product of claim 15, wherein the aggregated packet header comprises offsets that delineate a location for each of the packets combined in the aggregated packet.

20. The computer program product of claim 15, wherein the aggregated packet header is configured to be utilized to individually delineate and distribute the packets combined in the aggregated packet in accordance with offsets.
